(19) United States
(12) Patent Application Publication
(10) Pub. No.: US 2026/0353081 A1
(43) Pub. Date: Nov. 5, 2026

(54) LOGICAL ACCESS METHOD AND DEVICE USING ULTRA WIDE BAND COMMUNICATION

(71) Applicant: Samsung Electronics Co., Ltd., Suwon-si, Gyeonggi-do (KR)

(72) Inventor: Jieun KEUM, Suwon-si (KR)

(21) Appl. No.: 19/485,118

(22) PCT Filed: May 16, 2024
(86) PCT No.: PCT/KR2024/006653

§ 371 Date: Nov. 17, 2025

(30) Foreign Application Priority Data
May 17, 2023 (KR) 10-2023-0064010

(51) Int. Cl. H04W 12/06; H04B 1/7163; H04W 4/02; H04W 8/00; H04W 12/50

(52) U.S. Cl. CPC H04W 12/068; H04B 1/7163; H04W 4/023; H04W 8/005; H04W 12/50; H04B 2201/71634

(57) ABSTRACT

An operating method of a first ultra wide band (UWB) device, according to one embodiment of the present disclosure, may comprise the operations of: discovering a second UWB device through device discovery based on Bluetooth low energy (BLE) communication or UWB communication; and performing UWB ranging with the second UWB device in order to check whether the distance between the first UWB device and the second UWB device is less than or equal to a threshold value. At this time, if the distance between the first UWB device and the second UWB device according to the UWB ranging result is less than or equal to the threshold value, a service execution procedure or a device login supported by the second UWB device can be performed.

### CROSS-REFERENCE TO RELATED APPLICATION(S)

This application is a U.S. National Stage application under 35 U.S.C. §371 of an International application number PCT/KR2024/006653, filed on May 16, 2024, which is based on and claims priority of a Korean patent application number 10-2023-0064010, filed on May 17, 2023, in the Korean, the disclosure of which is incorporated by reference herein in its entirety.

### TECHNICAL FIELD

The disclosure relates to UWB communication, and more particularly, to a method and device for logical access through UWB communication.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wide band (UWB).

### DETAILED DESCRIPTION OF THE INVENTION

### Technical Problem

The disclosure provides a method and device for logical access through UWB communication.

### Technical Solution

A method of operating a first ultra wide band (UWB) device according to an embodiment of the disclosure may include an operation of discovering a second UWB device through device discovery based on Bluetooth low energy (BLE) communication or UWB communication, and an operation of performing UWB ranging with the second UWB device to identify whether a distance between the first UWB device and the second UWB device is equal to or less than a threshold. In this case, if the distance between the first UWB device and the second UWB device according to the UWB ranging result is equal to or less than the threshold, a device login or service execution procedure supported by the second UWB device may be performed.

A method of operating a second ultra wide band (UWB) device according to an embodiment of the disclosure may include an operation of discovering a first UWB device through device discovery based on Bluetooth low energy (BLE) communication or UWB communication, an operation of performing UWB ranging with the first UWB device to identify whether a distance between the first UWB device and the second UWB device is equal to or less than a threshold, and an operation of performing a device login or service execution procedure supported by the second UWB device if the distance between the first UWB device and the second UWB device according to the UWB ranging result is equal to or less than the threshold.

A first ultra wide band (UWB) device according to an embodiment of the disclosure includes a transceiver and a controller. The controller may discover a second UWB device through device discovery based on Bluetooth low energy (BLE) communication or UWB communication, and perform UWB ranging with the second UWB device to identify whether a distance between the first UWB device and the second UWB device is equal to or less than a threshold. If the distance between the first UWB device and the second UWB device according to the UWB ranging result is equal to or less than the threshold, a device login or service execution procedure supported by the second UWB device may be performed.

A second ultra wide band (UWB) device according to an embodiment of the disclosure includes a transceiver and a controller. The controller may discover a first UWB device through device discovery based on Bluetooth low energy (BLE) communication or UWB communication, perform UWB ranging with the first UWB device to identify whether a distance between the first UWB device and the second UWB device is equal to or less than a threshold, and if the distance between the first UWB device and the second UWB device according to the UWB ranging result is equal to or less than the threshold, perform a device login or service execution procedure supported by the second UWB device.

### Advantageous Effects

A method and device according to an embodiment of the disclosure may simplify a logical access procedure using UWB communication.

A method and device according to an embodiment of the disclosure may seamlessly link services to nearby devices according to user movement.

### BRIEF DESCRIPTION OF DRAWINGS

FIG. 1 illustrates an example architecture of a UWB device according to an embodiment of the disclosure;

FIG. 2 illustrates an example configuration of a framework of a UWB device according to an embodiment of the disclosure;

FIG. 3 illustrates a method for performing communication by a plurality of electronic devices according to an embodiment of the disclosure;

FIG. 4 is a view illustrating a fast identity online (FIDO) client to authenticator protocol (CTAP) according to an embodiment of the disclosure.

FIG. 5 illustrates a system including an access credential (AC) device and an AC reader according to an embodiment of the disclosure.

FIG. 6 is a view illustrating an automatic device login/logout method according to an embodiment of the disclosure.

FIGS. 7A and 7B are views illustrating an automatic website login/logout method according to an embodiment of the disclosure.

FIGS. 8A, 8B, and 8C are views illustrating a session transfer method according to an embodiment of the disclosure.

FIG. 9 is a view illustrating a session transfer method according to another embodiment of the disclosure.

FIG. 10 is a device diagram illustrating a first UWB device according to an embodiment of the disclosure.

FIG. 11 is a device diagram illustrating a second UWB device according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the disclosure is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the present disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term ‘unit’ means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units'. Further, the components and 'units’ may be implemented to execute one or more CPUs in a device or secure multimedia card. According to embodiments of the disclosure, a “. . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the disclosure are described in detail with reference to the accompanying drawings. Further, although a communication system using UWB is described in connection with embodiments of the disclosure, as an example, embodiments of the disclosure may also apply to other communication systems with similar technical background or features. For example, a communication system using Bluetooth or ZigBee may be included therein. Further, embodiments of the disclosure may be modified in such a range as not to significantly depart from the scope of the disclosure under the determination by one of ordinary skill in the art and such modifications may be applicable to other communication systems.

When determined to make the subject matter of the disclosure unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra wide band (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Controller” may be a ranging device that defines and controls ranging control messages (RCM) (or control messages).

“Controllee” may be a ranging device using a ranging parameter in the RCM (or control message) received from the controller.

“Ranging device” may be a device capable of performing UWB ranging. In the disclosure, the Ranging Device may be an Enhanced Ranging Device (ERDEV) defined in IEEE 802.15.4z or a FiRa Device defined by FiRa. The Ranging Device may be referred to as a UWB device.

“UWB-enabled Application” may be an application for UWB service. For example, the UWB-enabled Application may be an application using a Framework API for configuring an OOB Connector, a Secure Service, and/or a UWB service for a UWB session. In this disclosure, “UWB-enabled Application” may be abbreviated as an application or a UWB application. UWB-enabled Application may be a FiRa-enabled Application defined by FiRa.

“Framework” may be a component that provides access to Profiles, individual-UWB configuration and/or notifications. “Framework” may be, e.g., a collection of logical software components including Profile Manager, OOB Connector, Secure Service, and/or UWB service. In the disclosure, the Framework may be a FiRa Framework defined by FiRa.

“OOB Connector” may be a software component for establishing an out-of-band (OOB) connection (e.g., BLE connection) between Ranging Devices. In the disclosure, the OOB Connector may be a FiRa OOB Connector defined by FiRa.

“Profile” may be a previously defined set of UWB and OOB configuration parameters. In the disclosure, Profile may be a FiRa Profile defined by FiRa.

“Profile Manager” may be a software component that implements a profile available on the Ranging Device. In the disclosure, the Profile Manager may be a FiRa Profile Manager defined by FiRa.

“Service” may be an implementation of a use case that provides a service to an end-user.

“Smart Ranging Device” may be a ranging device that may implement an optional Framework API. In the disclosure, the Smart Ranging Device may be a FiRa Smart Device defined by FiRa.

“Global Dedicated File (GDF)” may be a root level of application specific data including data required to establish a USB session.

“Framework API” may be an API used by a UWB-enabled Application to communicate with the Framework.

“Initiator” may be a Ranging Device that initiates a ranging exchange.

“Object Identifier (OID)” may be an identifier of the application dedicated file (ADF) in the application data structure. “Application dedicated file (ADF)” may be, e.g., a data structure in an application data structure that may host an application or application specific data.

“Out-Of-Band (OOB)” may be data communication that does not use UWB as an underlying wireless technology.

“Ranging Data Set (RDS)” may be data (e.g., UWB session key, session ID, etc.) required to establish a UWB session when it is needed to protect confidentiality, authenticity and integrity.

“Responder” may be a ranging device that responds to the Initiator in a ranging exchange.

“STS” may be a ciphered sequence for increasing the integrity and accuracy of ranging measurement timestamps. The STS may be generated from the ranging session key.

Unlike “static STS,” “dynamic scrambled timestamp sequence (STS) mode” may be an operation mode in which the STS is not repeated during a ranging session. In this mode, the STS may be managed by the ranging device, and the ranging session key that generates STS may be managed by a secure component.

“Secure channel” may be a data channel that prevents overhearing and tampering.

“Secure Component” may be an entity (e.g., SE or TEE) having a defined security level that interfaces with UWBS for the purpose of providing RDS to UWBS, e.g., when dynamic STS is used.

“Secure Element (SE)” may be a tamper-resistant secure hardware component that may be used as a Secure Component in the Ranging Device.

“Secure ranging” may be ranging based on STS generated through a strong encryption operation.

“Secure Service” may be a software component for interfacing with a Secure Component, such as a Secure Element or Trusted Execution Environment (TEE).

“Service Data” may be data defined by a service provider that needs to be transferred between two ranging devices to implement a service.

“Service Provider” may be an entity that defines and provides hardware and software required to provide a specific service to an end-user.

“Static STS mode” is an operation mode in which STS is repeated during a session, and does not need to be managed by the Secure Component.

“UWB Service” may be a software component that provides access to the UWBS.

“UWB Session” may be a period from when the Controller and the Controllee start communication through UWB until the communication stops. A UWB Session may include ranging, data transfer, or both ranging and data transfer.

“UWB Session ID” may be an ID (e.g., a 32-bit integer) that identifies the UWB Session, shared between the controller and the controllee.

“UWB session key” may be a key used to protect the UWB Session. The UWB Session Key may be used to generate the STS. In this disclosure, the UWB session key may be a UWB ranging session key (URSK), and may be abbreviated as a session key.

“UWB subsystem (UWBS)” may be a hardware component implementing the UWB PHY and MAC layers specifications. UWBS may have an interface to Framework and an interface to Secure Component to search for RDS. In this disclosure, the UWB PHY and MAC specifications may be, e.g., FiRa PHY and FiRa MAC specifications defined by FiRa referring to IEEE 802.15.4/4z.

“UWB message” may be a message including a payload IE transmitted by the UWB device (e.g., ERDEV).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“Payload IE” may be referred to as a payload information element and may be included in the MAC payload of the UWB MAC frame defined in IEEE 802.15.4/4z. The MAC payload may include a plurality of payload IEs.

“Data transferIE” may be an additional payload IE for transmitting application data. Application data may be data transferred from a framework or application above the UWB MAC Layer. The data transfer IE may be used in the procedure for ranging between the initiator and the responder. In this case, the ranging message may include at least one or both of the payload IE for ranging and the data transfer IE for application data transfer. For example, the data transfer IE may be included and transmitted as part of the payload IE of the MAC payload of a ranging initiation message (RIM) for ranging, a ranging response message (RRM), a ranging final message (RFM), a measurement report message (MRM) and ranging result report message (RRRM). The data transfer IE may be transferred to the payload IE of the MAC payload of the DTM. For example, the data transfer IE may be transferred, together with the DTM payload IE, while being attached to the MAC payload portion of the poll DTM, response DTM, and final DTM.

“UWB channel” may be one of candidate UWB channels allocated for UWB communication. Candidate UWB channels allocated for UWB communication may be channels allocated for UWB communication defined in IEEE 802.15.4/4z. The UWB channel may be used for UWB ranging and/or transaction. For example, the UWB channel may be used for transmission/reception of a ranging frame RFRAME and/or transmission/reception of a data frame.

“One-way ranging (OWR)” may be a ranging scheme using a time difference of arrival (TDoA) localization method. The TDoA method corresponds to a method for locating a mobile device (tag device) based on a relative arrival time of a single message or multiple messages. For a description of OWR (TDoA), reference may be made to the description of IEEE 802.15.4z. As an example of the OWR scheme, an uplink (UL)-TDoA scheme may be included.

“Two-way ranging (TWR)” may be a ranging scheme capable of estimating a relative distance between two devices by measuring time of flight (ToF) through the exchange of ranging messages between the two devices. The TWR scheme may be one of double-sided two-way ranging (DS-TWR) and single-sided two-way ranging (SS-TWR). SS-TWR may be a procedure for performing ranging through one round-trip time measurement. DS-TWR may be a procedure for performing ranging through two round-trip time measurements. For a description of SS-TWR and DS-TWR, reference may be made to the description of IEEE 802.15.4z.

“DL-TDoA” may be called Downlink Time Difference of Arrival (DL-TDoA), reverse TDoA, and its default operation may be for the user equipment (UE) (tag device) to overhear the message of the anchor device while a plurality of anchor devices broadcast or exchange messages. The UE performing the DL-TDoA operation may overhear the messages transmitted by the two anchor devices to calculate a Time Difference of Arrival (TDoA) proportional to the difference between the distances between each anchor device and the UE. The UE may calculate a relative distance to the anchor device by using TDoA with several pairs of anchor devices and use it for positioning. The operation of the anchor device for DL-TDoA may be similar to that of Double Side-Two Way Ranging (DS-TWR) defined in IEEE 802.15.4z and may further include other useful time information so that the UE may calculate the TDoA. In the disclosure, DL-TDoA may be referred to as DL-TDoA localization.

“Anchor device” may be referred to as an anchor, a UWB anchor or a UWB anchor device and may be a UWB device deployed in a specific location to provide a positioning service. For example, the anchor device may be a UWB device installed by a service provider on a wall, ceiling, structure, or the like in a room to provide an indoor positioning service. Anchor devices may be divided into initiator anchors and responder anchors according to the order and role of transmitting messages.

“Initiator anchor” may be referred to as an initiator UWB anchor, an initiator anchor device, or the like and may announce the start of a specific ranging round. The initiator anchor may schedule a ranging slot for the responder anchors operating in the same ranging round to respond. The initiation message of the initiator anchor may be referred to as an initiator Downlink TDoA Message (DTM) or Poll message. The initiation message of the initiator anchor may include a transmission timestamp. The initiator anchor may additionally transfer an end message after receiving responses from the responder anchors. The end message of the initiator anchor may be referred to as Final DTM or Final message. The end message may include the time of the reply to the messages sent by the responder anchors. The end message may include a transmission timestamp.

“Responder anchor” may also be referred to as a Responder UWB anchor, a Responder UWB anchor device, a Responder anchor device, etc. The responder anchor may be a UWB anchor responding to the initiation message of the initiator anchor. The message with which the responder anchor responds may include the time of reply to the initiation message. The message with which the responder anchor responds may be referred to as a Responder DTM or a Response message. The response message of the responder anchor may include a transmission timestamp.

When determined to make the subject matter of the disclosure unnecessarily unclear, the detailed description of related known functions or features may be skipped in describing the disclosure.

Hereinafter, various embodiments of the disclosure are described with reference to the accompanying drawings.

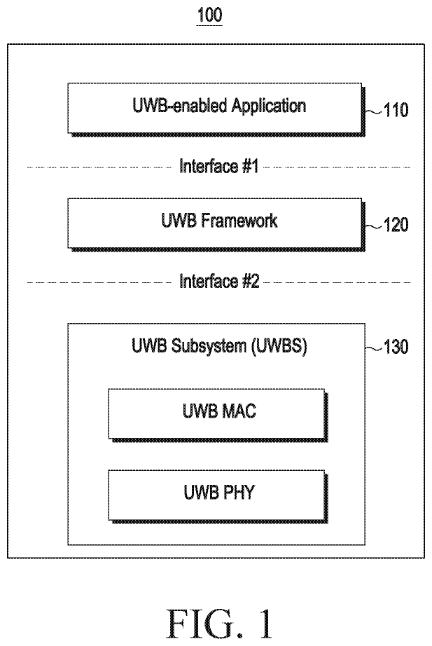

FIG. 1 illustrates an example architecture of a UWB device according to an embodiment of the disclosure;

In the disclosure, the UWB device 100 may be an electronic device supporting UWB communication. The UWB device 100 may be, e.g., a ranging device supporting UWB ranging. In an embodiment, the Ranging Device may be an Enhanced Ranging Device (ERDEV) defined in IEEE 802.15.4z or a FiRa Device defined by FiRa.

In the embodiment of FIG. 1, the UWB device 100 may interact with other UWB devices through a UWB session.

The UWB device 100 may implement a first interface (Interface #1) that is an interface between the UWB-enabled Application 110 and the Framework 120, and the first interface allows the UWB-enabled application 110 on the UWB device 100 to use the UWB capabilities of the UWB device 100 in a predetermined manner. In an embodiment, the first interface may be a Framework API or a proprietary interface, but is not limited thereto.

The UWB device 100 may implement a second interface (Interface #2) that is an interface between the UWB Framework 110 and the UWB subsystem (UWBS, 130). In an embodiment, the second interface may be a UWB Command Interface (UCI) or proprietary interface, but is not limited thereto.

Referring to FIG. 1, the UWB device 100 may include a UWB-enabled Application 110, a Framework (UWB Framework) 120, and/or a UWBS 130 including a UWB MAC Layer and a UWB Physical Layer. According to an embodiment, some entities may not be included in the UWB device, or additional entities (e.g., security layer) may be further included.

The UWB-enabled Application 110 may trigger establishment of a UWB session by a UWBS 130 through the first interface. According to an embodiment, the UWB-enabled Application 110 may use one of previously defined profiles (profile). For example, the UWB-enabled Application 110 may use one of the profiles defined in FiRa or a custom profile. The UWB-enabled Application 110 may use the first interface to handle related events, such as service discovery, ranging notifications, and/or error conditions.

The Framework 120 may provide access to Profiles, individual-UWB configuration and/or notifications. According to an embodiment, the Framework 120 may support at least one of a function for UWB ranging and transaction execution, a function to provide an interface to the application and UWBS 130, or a function to estimate the location of the device 100. The Framework 120 may be a set of software components. As described above, the UWB-enabled Application 110 may interface with the Framework 120 through the first interface, and the Framework 120 may interface with the UWBS 130 through the second interface.

Meanwhile, in the disclosure, the UWB-enabled Application 110 and/or Framework 120 may be implemented by an application processor (AP) (or processor). Accordingly, in the disclosure, the operation of the UWB-enabled Application 110 and/or the Framework 120 may be understood as performed by an AP (or a processor). In this disclosure, the framework may be referred to as an AP or a processor.

The UWBS 130 may be a hardware component including a UWB MAC Layer and a UWB Physical Layer. The UWBS 130 may perform UWB session management and may communicate with the UWBS of another UWB device. The UWBS 130 may interface with the Framework 120 through the second interface and may obtain the secure data from the Secure Component. In an embodiment, the Framework (or application processor) 120 may transmit a command to the UWBS 130 through UCI, and the UWBS 130 may transmit a response to the command to the Framework 120. The UWBS 130 may transfer a notification to the Framework 120 through the UCI.

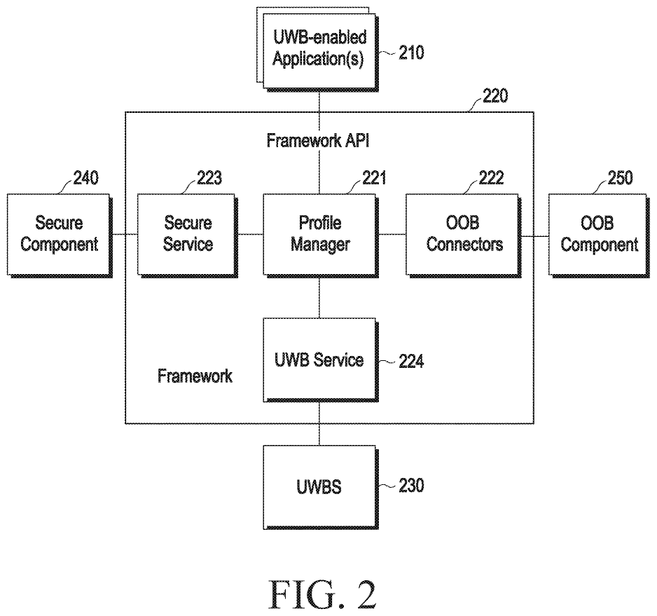

FIG. 2 illustrates an example configuration of a framework of a UWB device according to an embodiment of the disclosure;

The UWB device of FIG. 2 may be an example of the UWB device 100 of FIG. 1.

Referring to FIG. 2, the Framework 220 may include, e.g., software components, such as Profile Manager 221, OOB Connector(s) 222, Secure Service 223 and/or UWB service 224.

The Profile Manager 221 may serve to manage profiles available on the UWB device. Profile may be a set of parameters required to establish communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. The UWB-enabled Application 210 may communicate with the Profile Manager 221 through the first interface (e.g., Framework (API)).

The OOB Connector 222 may serve to establish an OOB connection with another device. The OOB Connector 222 may handle an OOB step including a discovery step and/or a connection step. The OOB component (e.g., BLE component) 250 may be connected to the OOB connector 222.

The Secure Service 223 may play a role of interfacing with a Secure Component 240, such as SE or TEE.

The UWB Service 224 may perform a role of managing the UWBS 230. The UWB Service 224 may provide access to the UWBS 230 from the Profile Manager 221 by implementing the second interface.

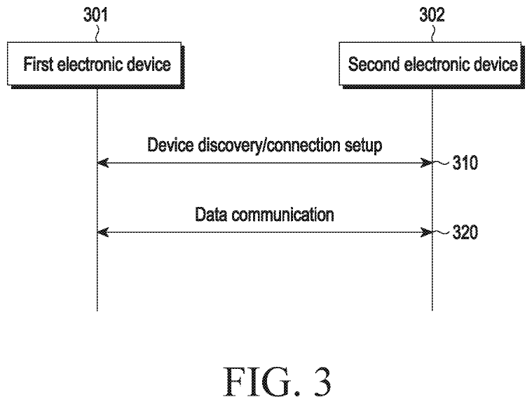

FIG. 3 illustrates a method for performing communication by a plurality of electronic devices according to an embodiment of the disclosure;

The first electronic device 301 and the second electronic device 302 of FIG. 3 may be, e.g., the UWB devices of FIG. 1 or 2.

Referring to FIG. 3, the first electronic device 301 and the second electronic device 302 may perform a device discovery/connection setup procedure 310 and a data communication procedure 320. The device discovery/connection setup procedure 310 and data communication procedure 320 may be managed or controlled by the MAC layer (entity) of the electronic device.

### (1) Device Search/Connection Setup Procedure

In the disclosure, the device discovery/connection setup procedure 310 may be a prior procedure performed before the data communication procedure 320. As an example, the device discovery/connection setup procedure 310 may be performed over OOB communication (channel), NB communication (channel), and/or UWB communication (channel).

The device discovery/connection setup procedure 310 may include at least one of the following operations.
Device discovery operation: An operation in which the electronic device searches for (discovers) another UWB devices. The device discovery operation may include an operation for transmitting/receiving an advertisement message. In the disclosure, the device discovery operation may be a discovery operation or an advertising operation.
Connection setup operation: An operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (controllee performance parameters), UWB configuration parameters, session key-related parameters) for configuring a UWB session through a secure channel established through the connection setup operation may be negotiated between two electronic devices.

### (2) Data Communication Procedure

In the disclosure, the data communication procedure 320 may be a procedure for transmitting and receiving data using UWB communication. As an embodiment, the data communication procedure may be performed by UWB communication or NB communication.

The data communication procedure 320 may include at least one of the following operations.
UWB ranging operation: An operation in which the electronic device performs UWB ranging with another electronic device in a preset UWB ranging scheme (e.g., OWR, SS-TWR, DS-TWR scheme). As an embodiment, the UWB ranging operation may include a ToF measurement operation and/or an AoA measurement operation.
Transaction operation: An operation in which an electronic device exchanges service data with another electronic device.

Meanwhile, research is being actively conducted on methods for automatically logging into a target device (e.g., a laptop or personal computer (PC)) through user authentication of an electronic device (e.g., a mobile device or wearable device). For example, when a user of an electronic device approaches close to a target device, a login operation for devices and/or services of the target device may be automatically performed. Accordingly, user experience (UX) is improved and services may be automatically and seamlessly linked according to user movement.

The disclosure proposes a method for automatically logging into devices and/or services within a target device when a user (or electronic device) moves close to the target device, even without separate user authorization, utilizing UWB's secure ranging function. Further, an embodiment of the disclosure may provide a method for automatically logging off devices and/or services within a target device when a user (or electronic device) moves away from the target device, utilizing UWB's accurate distance measurement function (static, provisioned ranging).

For example, when a user (or electronic device) moves to a position close to a PC that is a target device, an electronic device and/or a target device may control PC login (e.g., Windows unlock) to be automatically performed using a UWB function.

For example, when a user (or electronic device) moves to a position close to a target device, an electronic device and/or a target device may control automatic login to a website within the target device using a UWB function.

For example, when a user (or electronic device) moves to a position close to a target device, an electronic device and/or a target device may control service transfer to be performed between the target device and the electronic device using a UWB function.

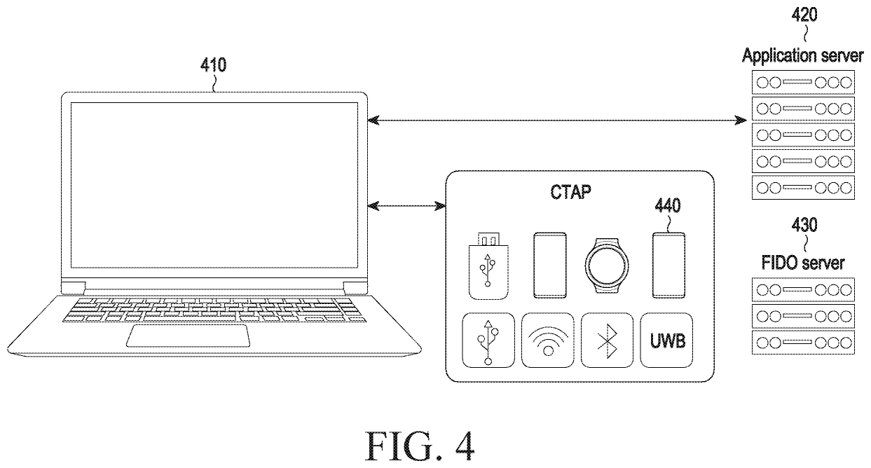

FIG. 4 is a view illustrating a fast identity online (FIDO) client to authenticator protocol (CTAP) according to an embodiment of the disclosure.

Fast identity online (FIDO) is an authentication method utilizing biometric recognition technology in an online environment. FIDO may be a simple and secure authentication technology that generates an authentication result value through an authentication device (e.g., universal serial bus (USB), mobile phone, or wearable device) of a client rather than transmitting authentication data to a server, transmits it to a server (or FIDO server), and verifies the authentication result value at the server (or FIDO server).

Among authentication standards presented by the FIDO Alliance, which is a FIDO technical standards organization, universal authentication framework (UAF) may be an authentication standard method that authenticates through user biometric information such as fingerprint, voice, or facial recognition without using a password. Among authentication standards presented by the FIDO Alliance, universal 2nd factor (U2F) may be a two-factor authentication method that uses a separate authentication device such as USB or smart card storing additional security information together with existing ID and password authentication methods.

An electronic device may provide security through user biometric information without using a password in online services using the UAF protocol.

A user of an electronic device may register the electronic device with a service (or server) by selecting a local authentication mechanism such as swiping a finger, looking at a camera, speaking into a microphone, entering a personal identification number (PIN), or a combination thereof.

An electronic device may select a mechanism provided to a user from a service using the UAF protocol. Once an electronic device is registered with a service (or server), a user only needs to repeat a local authentication action whenever authentication to that service is required, and no longer needs to enter a password if authenticating on that electronic device.

FIDO 2.0 is a technology that enables the use of biometric authentication in all online environments including not only mobile but also PC, and in FIDO 2.0, Web Authentication (WebAuthn) and Client-to-Authenticator Protocol (CTAP) technologies are proposed in addition to existing UAF and U2F. CTAP may enable the use of FIDO authentication services without installing separate programs in PC and mobile web environments.

Referring to FIG. 4, a system may include a target device 410 (e.g., PC), an application server 420 providing applications/services to the target device 410, a FIDO server 430, and an authentication device 440 (e.g., universal serial bus (USB), mobile phone, or wearable device).

The authentication device 440 may perform a registration process by transmitting a first message (or makeCredential message) including a stored user certificate to the FIDO server 430.

The authentication device 440 may perform an authentication process (or private key signature process) by transmitting a second message (getAssertion message) including a value signed with a user private key within the device to the FIDO server 430. The FIDO server 430 may extract electronic signature information from the received second message (getAssertion message) and verify the electronic signature.

The disclosure proposes a technology for introducing UWB technology to FIDO CTAP. When an authentication device 440 supporting UWB communication (e.g., mobile device, wearable device, etc.) approaches a target device 410 (e.g., PC), without requiring additional plug-ins for the target device 410, the authentication device 440 may be automatically approved for devices and/or services (e.g., websites) within the target device 410 through local authentication action utilizing user biometric information.

According to an embodiment, the authentication device 440 may perform website credential transmission and distance measurement utilizing a hybrid session through UWB, and control automatic login functions for devices and/or services to be performed on the target device 410 when conditions are satisfied.

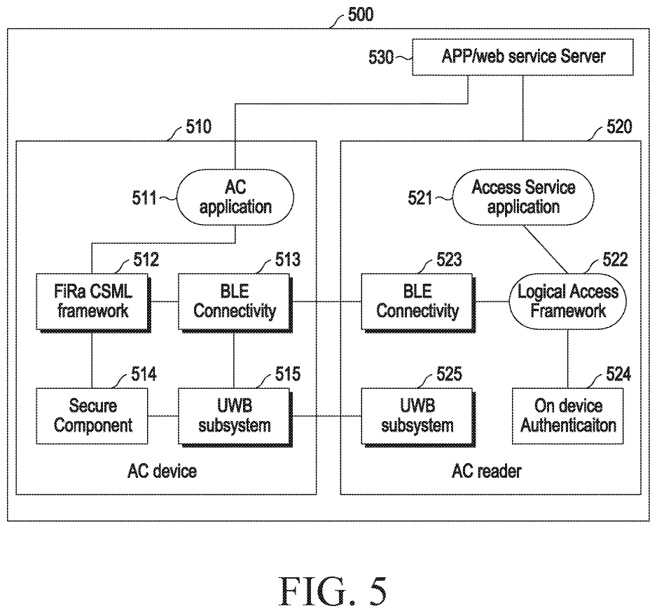

FIG. 5 illustrates a system including an access credential (AC) device and an AC reader according to an embodiment of the disclosure.

Referring to FIG. 5, a system 500 includes an access credential (AC) device 510, an access credential (AC) reader 520, and an application/web service server 530.

The AC device 510 may be implemented as any one of the UWB device 100 of FIG. 1, the UWB device of FIG. 2, the first electronic device 301 of FIG. 3, or the second electronic device 302. The AC device 510 may be an authentication device for logical access and may be a device requesting authentication.

The AC device 510 may include an access credential (AC) application 511, FiRa common service management layer (CSML) framework 512, BLE connectivity 513, secure component 514, and UWB subsystem 515.

The AC application 511 may perform and/or control communication between the AC device 510 and the application/web service server 530.

The FiRa CSML framework 512 may be implemented as the UWB Framework 120 of FIG. 1 or the Framework 220 of FIG. 2. The FiRa CSML framework 512 may be a collection of logical software components for CSML defined in FiRa. The AC device 510 may support secure channel setup defined in CSML.

The BLE connectivity 513 may perform the same or substantially the same function as the OOB component 250 of FIG. 2. The BLE connectivity 513 may exchange data and/or messages by performing BLE communication with the BLE connectivity 523 of the AC reader 520.

The secure component 514 may perform the same or substantially the same function as the secure component 240 of FIG. 2.

The UWB subsystem 515 may perform the same or substantially the same function as the UWBS 130 of FIG. 1 or the UWBS 230 of FIG. 2. The UWB subsystem 515 may exchange data and/or messages by performing UWB communication with the UWB subsystem 525 of the AC reader 520.

The AC reader 520 may be implemented as any one of the UWB device 100 of FIG. 1, the UWB device of FIG. 2, the first electronic device 301 of FIG. 3, or the second electronic device 302. The AC reader 520 may be a device for logical access and may be a device that reads access credentials.

The AC reader 520 may include an access service application 521, Logical Access Framework 522, BLE connectivity 523, on-device authentication 524, and UWB subsystem 525.

The access service application 521 may perform and/or control communication between the AC reader 520 and the application/web service server 530.

The Logical Access Framework 522 may be implemented as the UWB Framework 120 of FIG. 1 or the Framework 220 of FIG. 2. The Logical Access Framework 522 may support Logical Access Service defined in FiRa. The Logical Access Framework 522 may support FIDO Universal Authentication Framework (UAF) to register the AC device 510 and/or the AC reader 520 with the application/web service server 530 (or web service).

The BLE connectivity 523 may perform the same or substantially the same function as the OOB component 250 of FIG. 2. The BLE connectivity 523 may exchange data and/or messages by performing BLE communication with the BLE connectivity 513 of the AC device 510.

The on-device authentication module 524 may perform authentication procedures for devices and/or services within the AC reader 520.

The UWB subsystem 525 may perform the same or substantially the same function as the UWBS 130 of FIG. 1 or the UWBS 230 of FIG. 2. The UWB subsystem 525 may exchange data and/or messages by performing UWB communication with the UWB subsystem 515 of the AC device 510.

The application/web service server 530 may provide applications and/or web services to the AC device 510 or the AC reader 520. According to an embodiment, the application/web service server 530 may perform authentication-related procedures for devices and/or services requested by the AC device 510 and/or the AC reader 520 through communication with the AC application 511 and/or the access service application 521.

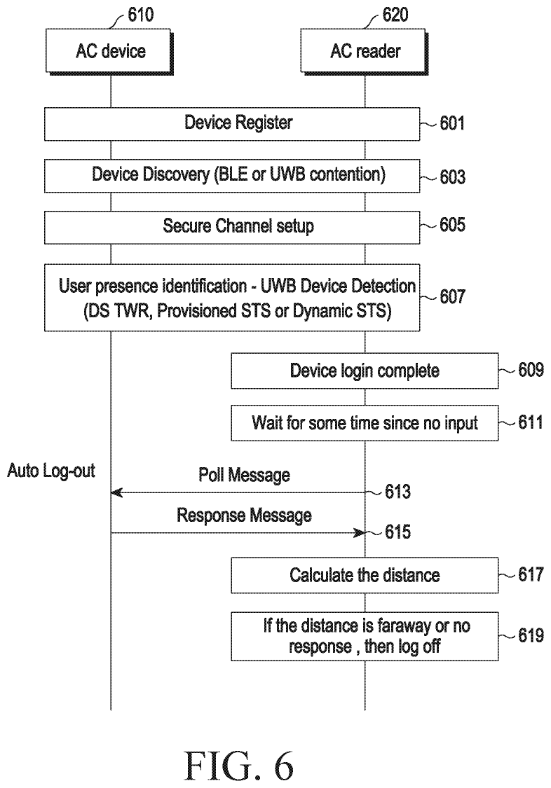

FIG. 6 is a view illustrating an automatic device login/logout method according to an embodiment of the disclosure.

Referring to FIG. 6, the AC device 610 may be implemented as any one of the UWB device 100 of FIG. 1, the UWB device of FIG. 2, the first electronic device 301 of FIG. 3, the second electronic device 302, or the AC device 510 of FIG. 5. The AC reader 620 may be implemented as any one of the UWB device 100 of FIG. 1, the UWB device of FIG. 2, the first electronic device 301 of FIG. 3, the second electronic device 302, or the AC reader 520 of FIG. 5.

According to an embodiment, the AC device 610 and the AC reader 620 may support a user authentication method (e.g., fingerprint or iris recognition). According to an embodiment, the AC device 610 and the AC reader 620 may support secure channel setup defined in CSML. According to an embodiment, the AC device 610 and the AC reader 620 may support DS-TWR.

In operation 601, the AC device 610 and the AC reader 620 may perform a device register procedure between them. According to an embodiment, the device register procedure between the AC device 610 and the AC reader 620 may be performed in advance.

In operation 603, the AC device 610 and the AC reader 620 may perform a device discovery procedure through BLE or contention based UWB. According to an embodiment, the AC device 610 may discover the AC reader 620 through BLE or contention based UWB. According to an embodiment, the AC reader 620 may discover the AC device 610 through BLE or contention based UWB.

In operation 605, the AC device 610 and the AC reader 620 may set up a secure channel for communication between them. According to an embodiment, the secure channel may be a data channel that prevents overhearing and tampering. According to an embodiment, the AC device 610 and/or the AC reader 620 may generate a secure channel by utilizing a key received during device register in operation 601 through in-device authentication (e.g., user biometric information verification).

According to an embodiment, the AC device 610 and/or the AC reader 620 may generate an STS value for UWB secure ranging in operation 605 (secure channel setup) by utilizing a key generated as a result of the device register procedure as a session key.

According to an embodiment, a secure channel may be generated on the FiRa BLE generic attribute profile (GATT) service.

According to an embodiment, a secure channel may be generated through Application Protocol Data Unit (APDU) command transmission on UWB In-band. The APDU command may be a command used when communicating with an Application Data Structure within a UWB device.

In operation 607, the AC device 610 and the AC reader 620 may identify whether the distance between the AC device 610 and the AC reader 620 is equal to or less than a threshold based on a UWB device detection procedure through UWB ranging (user presence identification). According to an embodiment, the AC device 610 and the AC reader 620 may perform double-sided two-way ranging (DS-TWR) to identify whether the distance between the AC device 610 and the AC reader 620 is equal to or less than a threshold (user presence identification). According to an embodiment, the AC device 610 and the AC reader 620 may identify whether the distance between the AC device 610 and the AC reader 620 is equal to or less than a threshold based on provisioned STS (user presence identification). According to an embodiment, the AC device 610 and the AC reader 620 may identify whether the distance between the AC device 610 and the AC reader 620 is equal to or less than a threshold based on dynamic STS (user presence identification).

If it is identified in operation 607 that the distance between the AC device 610 and the AC reader 620 is equal to or less than the threshold, the AC reader 620 may perform and/or complete a device login operation in operation 609.

In operation 611, the AC reader 620 may wait until there is no input for a predetermined period of time.

If there is no input in the AC reader 620 for a predetermined period of time in operation 611, the AC reader 620 may transmit a Poll message to the AC device 610 in operation 613. In operation 615, the AC device 610 may transmit a Response message corresponding to the Poll message to the AC reader 620. According to an embodiment, the AC reader 620 may wait for a predetermined period of time if the corresponding Response message is not received after transmitting the Poll message.

In operation 617, the AC reader 620 may calculate the distance between the AC reader 620 and the AC device 610 based on the Poll message and the Response message.

In operation 619, the AC reader 620 may perform and/or complete a device log off operation if the distance between the AC reader 620 and the AC device 610 according to the calculation result of operation 617 is equal to or greater than the threshold, or if the corresponding Response message is not received for a set time after transmitting the Poll message.

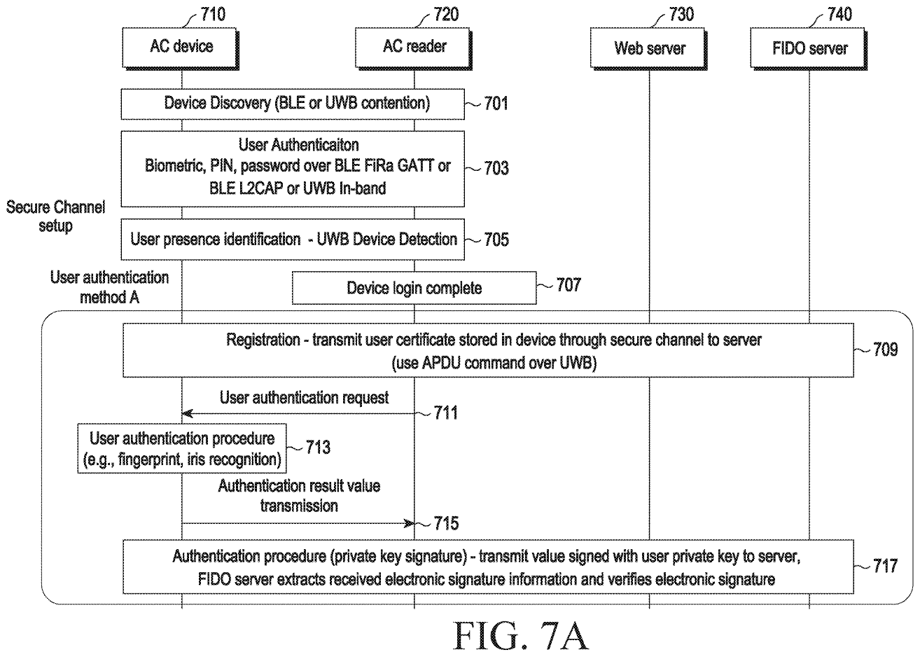

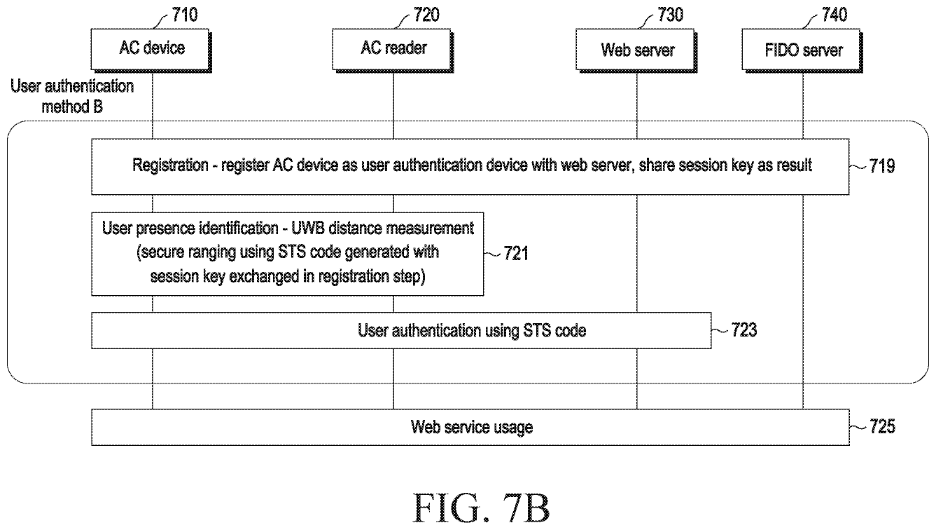

FIGS. 7A and 7B are views illustrating an automatic website login/logout method according to an embodiment of the disclosure.

Referring to FIGS. 7A and 7B, a system may include an AC device 710, an AC reader 720, a web server 730, and a FIDO server 740.

The AC device 710 may be implemented as any one of the UWB device 100 of FIG. 1, the UWB device of FIG. 2, the first electronic device 301 of FIG. 3, the second electronic device 302, or the AC device 510 of FIG. 5. The AC reader 720 may be implemented as any one of the UWB device 100 of FIG. 1, the UWB device of FIG. 2, the first electronic device 301 of FIG. 3, the second electronic device 302, or the AC reader 520 of FIG. 5.

According to an embodiment, the AC device 710 and the AC reader 720 may operate according to FIDO and CTAP standard specifications. According to an embodiment, the AC device 710 and the AC reader 720 may support a user authentication method (e.g., fingerprint or iris recognition). According to an embodiment, the AC device 710 and the AC reader 720 may support secure ranging using Dynamic STS or Provisioned STS. According to an embodiment, secure ranging may be an alternative to a user authentication method according to security requirements of the web server 730.

In operation 701, the AC device 710 and the AC reader 720 may perform a device discovery procedure. According to an embodiment, the AC device 710 and the AC reader 720 may perform a device discovery procedure through BLE or contention-based UWB.

In operation 703, the AC device 710 and the AC reader 720 may perform a user authentication procedure. According to an embodiment, the AC device 710 may perform a user authentication procedure by transmitting authentication information including at least one of biometric information, PIN, and password to the AC reader 720. According to an embodiment, the AC device 710 may transmit the authentication information to the AC reader 720 through FiRa BLE generic attribute profile (GATT) or BLE logical link control and adaption protocol (L2CAP) or UWB In-band.

According to an embodiment, the AC device 710 and the AC reader 720 may set up a secure channel for communication between them.

In operation 705, the AC device 710 and the AC reader 720 may identify whether the distance between the AC device 710 and the AC reader 720 is equal to or less than a threshold based on a UWB device detection procedure through UWB ranging (user presence identification). According to an embodiment, the AC device 710 and the AC reader 720 may perform double-sided two-way ranging (DS-TWR) to identify whether the distance between the AC device 710 and the AC reader 720 is equal to or less than a threshold (user presence identification). According to an embodiment, the AC device 710 and the AC reader 720 may identify whether the distance between the AC device 710 and the AC reader 720 is equal to or less than a threshold based on provisioned STS (user presence identification). According to an embodiment, the AC device 710 and the AC reader 720 may identify whether the distance between the AC device 710 and the AC reader 720 is equal to or less than a threshold based on dynamic STS (user presence identification).

If it is identified in operation 705 that the distance between the AC device 710 and the AC reader 720 is equal to or less than the threshold, the AC reader 720 may perform and/or complete a device login operation in operation 707.

Thereafter, the AC device 710 and the AC reader 720 may perform at least one of user authentication method A and user authentication method B. According to an embodiment, the AC device 710 and the AC reader 720 may selectively perform user authentication method A or user authentication method B according to security requirements of the service. According to an embodiment, the AC device 710 and the AC reader 720 may perform both user authentication method A and user authentication method B.

### <User Authentication Method A>

In operation 709, at least one of the AC device 710, the AC reader 720, the web server 730, and the FIDO server 740 may perform a register procedure. According to an embodiment, the AC device 710 and/or the AC reader 720 may transmit a user certificate stored in the device to the web server 730 and/or the FIDO server 740 through a secure channel. According to an embodiment, the AC device 710 and/or the AC reader 720 may transmit/receive an APDU command including a user certificate through device UWB.

In operation 711, the AC reader 720 may transmit a user authentication request message to the AC device 710.

In operation 713, the AC device 710 may perform a user authentication procedure. For example, the AC device 710 may perform a user authentication procedure through user fingerprint or iris recognition.

In operation 715, the AC device 710 may transmit an authentication result value to the AC reader 720. According to an embodiment, the authentication result value may be transmitted while being included in a UWB command set within FIDO CTAP.

In operation 717, at least one of the AC device 710, the AC reader 720, the web server 730, and the FIDO server 740 may perform an authentication procedure (private key signature). According to an embodiment, the AC device 710 and/or the AC reader 720 may transmit signature information (or a value signed with a user private key) to the web server 730 and/or the FIDO server 740. According to an embodiment, the FIDO server 740 may extract the received signature information (or value signed with a user private key) and verify the electronic signature.

### <User Authentication Method B>

In operation 719, at least one of the AC device 710, the AC reader 720, and the web server 730 may register the AC device 710 with the web server 730 as a user authentication device. According to an embodiment, the AC device 710, the AC reader 720, and the web server 730 may share the same session key.

In operation 721, the AC device 710 and the AC reader 720 may measure the distance between them through UWB ranging and identify whether the distance between the AC device 710 and the AC reader 720 is equal to or less than a threshold (user presence identification). According to an embodiment, the AC device 710 and the AC reader 720 may perform secure ranging based on an STS code generated using the session key exchanged in operation 719.

In operation 723, at least one of the AC device 710, the AC reader 720, and the web server 730 may perform a user authentication procedure using the STS code.

After performing at least one of user authentication method A and user authentication method B, in operation 725, at least one of the AC device 710, the AC reader 720, the web server 730, and the FIDO server 740 may perform related operations to use a web service in the AC device 710.

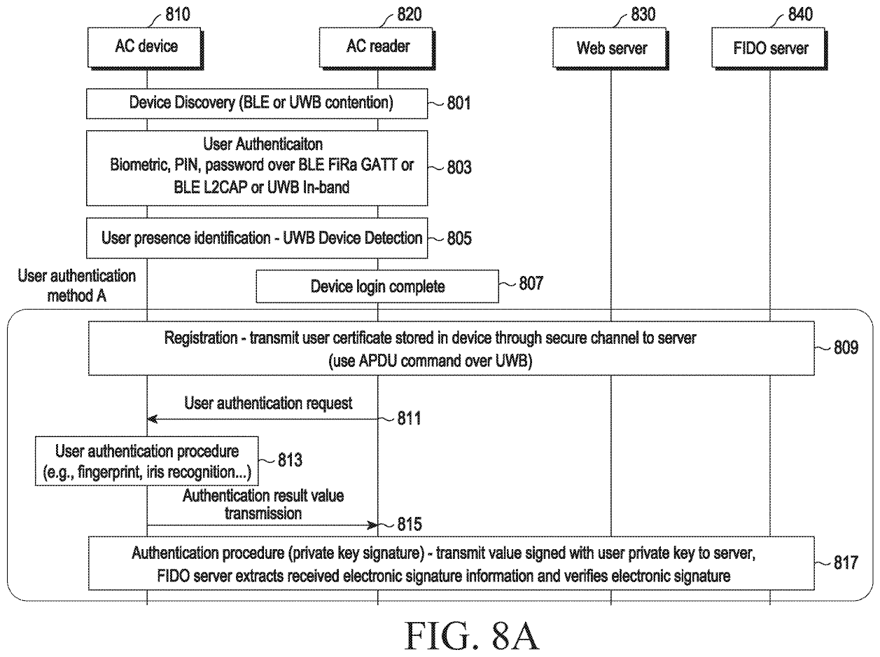

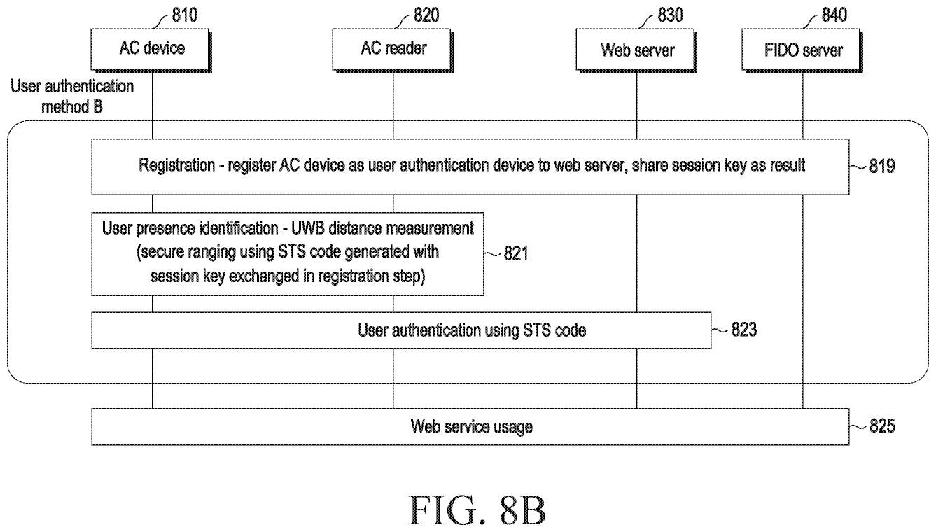

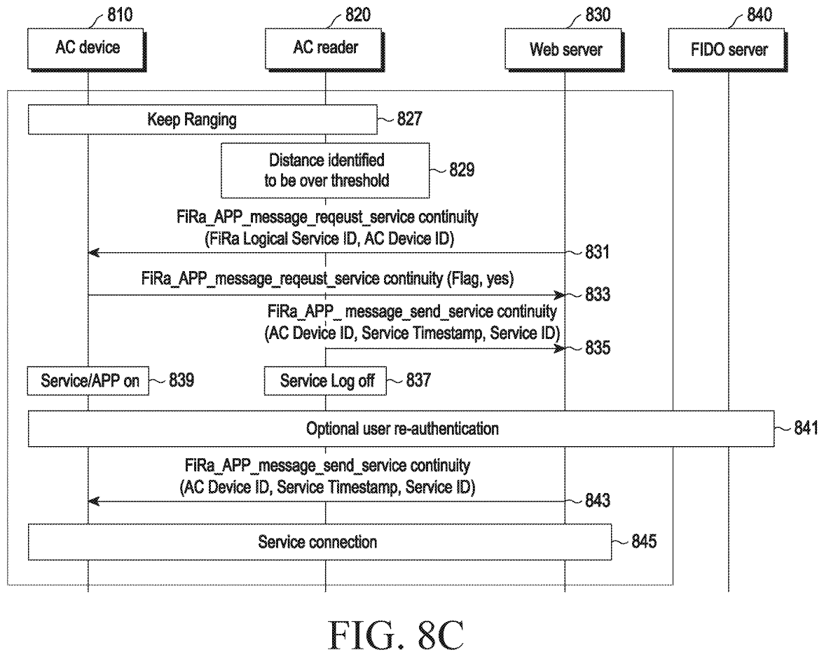

FIGS. 8A, 8B, and 8C are views illustrating a session transfer method according to an embodiment of the disclosure.

Referring to FIGS. 8A, 8B, and 8C, a system may include an AC device 810, an AC reader 820, a web server 830, and a FIDO server 840.

The AC device 810 may be implemented as any one of the UWB device 100 of FIG. 1, the UWB device of FIG. 2, the first electronic device 301 of FIG. 3, the second electronic device 302, or the AC device 510 of FIG. 5. According to an embodiment, the AC device 810 may be implemented as a mobile device.

The AC reader 820 may be implemented as any one of the UWB device 100 of FIG. 1, the UWB device of FIG. 2, the first electronic device 301 of FIG. 3, the second electronic device 302, or the AC reader 520 of FIG. 5. According to an embodiment, the AC reader 820 may be implemented as a PC.

According to an embodiment, the AC device 810 and the AC reader 820 may operate according to FIDO and CTAP standard specifications. According to an embodiment, the AC device 810 and the AC reader 820 may support a user authentication method (e.g., fingerprint or iris recognition). According to an embodiment, the AC device 810 and the AC reader 820 may support secure ranging using Dynamic STS or Provisioned STS. According to an embodiment, secure ranging may be an alternative to a user authentication method according to security requirements of the web server 830.

In operation 801, the AC device 810 and the AC reader 820 may perform a device discovery procedure. According to an embodiment, the AC device 810 and the AC reader 820 may perform a device discovery procedure through BLE or contention-based UWB.

In operation 803, the AC device 810 and the AC reader 820 may perform a user authentication procedure. According to an embodiment, the AC device 810 may perform a user authentication procedure by transmitting authentication information including at least one of biometric information, PIN, and password to the AC reader 820. According to an embodiment, the AC device 810 may transmit the authentication information to the AC reader 820 through FiRa BLE generic attribute profile (GATT) or BLE logical link control and adaption protocol (L2CAP) or UWB In-band.

According to an embodiment, the AC device 810 and the AC reader 820 may set up a secure channel for communication between them.

In operation 805, the AC device 810 and the AC reader 820 may identify whether the distance between the AC device 810 and the AC reader 820 is equal to or less than a threshold based on a UWB device detection procedure through UWB ranging (user presence identification). According to an embodiment, the AC device 810 and the AC reader 820 may perform double-sided two-way ranging (DS-TWR) to identify whether the distance between the AC device 810 and the AC reader 820 is equal to or less than a threshold (user presence identification). According to an embodiment, the AC device 810 and the AC reader 820 may identify whether the distance between the AC device 810 and the AC reader 820 is equal to or less than a threshold based on provisioned STS (user presence identification). According to an embodiment, the AC device 810 and the AC reader 820 may identify whether the distance between the AC device 610 and the AC reader 620 is equal to or less than a threshold based on dynamic STS (user presence identification).

If it is identified in operation 805 that the distance between the AC device 810 and the AC reader 820 is equal to or less than the threshold, the AC reader 820 may perform and/or complete a device login operation in operation 807.

Thereafter, the AC device 810 and the AC reader 820 may perform at least one of user authentication method A and user authentication method B. According to an embodiment, the AC device 810 and the AC reader 820 may selectively perform user authentication method A or user authentication method B according to security requirements of the service. According to an embodiment, the AC device 810 and the AC reader 820 may perform both user authentication method A and user authentication method B.

### <User Authentication Method A>

In operation 809, at least one of the AC device 810, the AC reader 820, the web server 830, and the FIDO server 840 may perform a register procedure. According to an embodiment, the AC device 810 and/or the AC reader 820 may transmit a user certificate stored in the device to the web server 830 and/or the FIDO server 840 through a secure channel. According to an embodiment, the AC device 810 and/or the AC reader 820 may transmit/receive an APDU command including a user certificate through device UWB.

In operation 811, the AC reader 820 may transmit a user authentication request message to the AC device 810.

In operation 813, the AC device 810 may perform a user authentication procedure. For example, the AC device 810 may perform a user authentication procedure through user fingerprint or iris recognition.

In operation 815, the AC device 810 may transmit an authentication result value to the AC reader 820. According to an embodiment, the authentication result value may be transmitted while being included in a UWB command set within FIDO CTAP.

In operation 817, at least one of the AC device 810, the AC reader 820, the web server 830, and the FIDO server 840 may perform an authentication procedure (private key signature). According to an embodiment, the AC device 810 and/or the AC reader 820 may transmit signature information (or a value signed with a user private key) to the web server 830 and/or the FIDO server 840. According to an embodiment, the FIDO server 840 may extract the received signature information (or value signed with a user private key) and verify the electronic signature.

### <User Authentication Method B>

In operation 819, at least one of the AC device 810, the AC reader 820, and the web server 830 may register the AC device 810 with the web server 830 as a user authentication device. According to an embodiment, the AC device 810, the AC reader 820, and the web server 830 may share the same session key.

In operation 821, the AC device 810 and the AC reader 820 may measure the distance between them through UWB ranging and identify whether the distance between the AC device 810 and the AC reader 820 is equal to or less than a threshold (user presence identification). According to an embodiment, the AC device 810 and the AC reader 820 may perform secure ranging based on an STS code generated using the session key exchanged in operation 819.

In operation 823, at least one of the AC device 810, the AC reader 820, and the web server 830 may perform a user authentication procedure using the STS code.

After performing at least one of user authentication method A and user authentication method B, in operation 825, at least one of the AC device 810, the AC reader 820, the web server 830, and the FIDO server 840 may perform related operations to use a web service in the AC device 810.

In operation 827, the AC device 810 and the AC reader 820 may continuously perform UWB ranging (keep ranging). In operation 829, the AC reader 820 may identify that the distance between the AC device 810 and the AC reader 820 is equal to or greater than a threshold based on the UWB ranging result.

In operation 831, the web server 830 may transmit a first message (FiRa_APP_message_request_service continuity) requesting service continuity, including at least one of a Service ID (or FiRa Logical Service ID) and an ID of the AC device 810, to the AC device 810. The first message (FiRa_APP_message_request_service continuity) may be a message inquiring whether to continue using the web service in the AC device 810.

In operation 833, the AC device 810 may transmit a second message (FiRa_APP_message_request_service continuity) requesting service continuity, including a flag (e.g., yes), to the web server 830. According to an embodiment, the flag may indicate whether to allow session transfer to the AC device 810 for service continuity. The second message (FiRa_APP_message_request_service continuity) may indicate that the web service will continue to be used in the AC device 810.

In operation 835, the AC reader 820 may transmit a third message (FiRa_APP_message_send_service continuity) for service continuity, including at least one of an ID of the AC device 810, service timestamp information, and a Service ID (or FiRa Logical Service ID), to the web server 830.

In operation 837, the AC reader 820 may perform a service log off operation.

In operation 839, the AC device 810 may turn on (or activate) a service/application.

In operation 841, at least one of the AC device 810, the AC reader 820, the web server 830, and the FIDO server 840 may optionally perform user re-authentication.

In operation 843, the web server 830 may transmit a third message (FiRa_APP_message_send_service continuity) for service continuity, including at least one of an ID of the AC device 810, service timestamp information, and a Service ID (or FiRa Logical Service ID), to the AC device 810.

In operation 845, the AC device 810 may be service-connected with the web server 830.

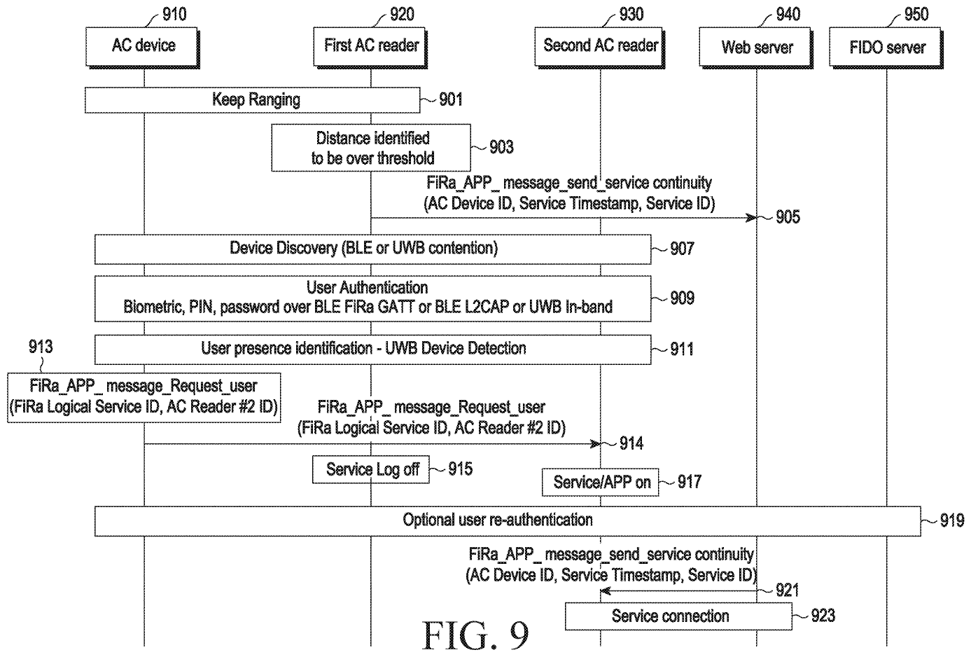

FIG. 9 is a view illustrating a session transfer method according to another embodiment of the disclosure.

Referring to FIG. 9, a system may include an AC device 910, a first AC reader 920, a second AC reader 930, a web server 940, and a FIDO server 950.

The AC device 910 may be implemented as any one of the UWB device 100 of FIG. 1, the UWB device of FIG. 2, the first electronic device 301 of FIG. 3, the second electronic device 302, or the AC device 510 of FIG. 5.

Each of the first AC reader 920 and the second AC reader 930 may be implemented as any one of the UWB device 100 of FIG. 1, the UWB device of FIG. 2, the first electronic device 301 of FIG. 3, the second electronic device 302, or the AC reader 520 of FIG. 5.

According to an embodiment, the AC device 910, the first AC reader 920, and the second AC reader 930 may operate according to FIDO and CTAP standard specifications. According to an embodiment, the AC device 910, the first AC reader 920, and the second AC reader 930 may support a user authentication method (e.g., fingerprint or iris recognition). According to an embodiment, the AC device 910, the first AC reader 920, and the second AC reader 930 may support secure ranging using Dynamic STS or Provisioned STS. According to an embodiment, secure ranging may be an alternative to a user authentication method according to security requirements of the web server 830.

In operation 901, the AC device 910 and the first AC reader 920 may continuously perform UWB ranging (keep ranging). In operation 903, the first AC reader 920 may identify that the distance between the AC device 890 and the first AC reader 920 is equal to or greater than a threshold based on the UWB ranging result.

In operation 905, the first AC reader 920 may transmit a first message (FiRa_APP_message_send_service continuity) for service continuity, including at least one of an ID of the AC device 910, service timestamp information, and a Service ID (or FiRa Logical Service ID), to the web server 940.

In operation 907, the AC device 910 and the second AC reader 930 may perform a device discovery procedure. According to an embodiment, the AC device 910 and the second AC reader 930 may perform a device discovery procedure through BLE or contention-based UWB.

In operation 909, the AC device 910 and the second AC reader 930 may perform a user authentication procedure. According to an embodiment, the AC device 910 may perform a user authentication procedure by transmitting authentication information including at least one of biometric information, PIN, and password to the second AC reader 930. According to an embodiment, the AC device 910 may transmit the authentication information to the second AC reader 930 through FiRa BLE generic attribute profile (GATT) or BLE logical link control and adaption protocol (L2CAP) or UWB In-band.

In operation 911, the AC device 910 and the second AC reader 930 may identify whether the distance between the AC device 910 and the second AC reader 930 is equal to or less than a threshold based on a UWB device detection procedure through UWB ranging (user presence identification). According to an embodiment, the AC device 910 and the second AC reader 930 may perform double-sided two-way ranging (DS-TWR) to identify whether the distance between the AC device 910 and the second AC reader 930 is equal to or less than a threshold (user presence identification).

In operation 913, the AC device 910 may identify in response to user input that the second AC reader 930 will continue to use the service (or log in to the service) after the first AC reader 920 logs off the service. According to an embodiment, the AC device 910 may generate a second message (FiRa_APP_message_request_user) according to a user request including at least one of an ID of the second AC reader 930 and a Service ID (or FiRa Logical Service ID).

In operation 914, the AC device 910 may transmit the second message (FiRa_APP_message_request_user) including at least one of the ID of the second AC reader 930 and the Service ID (or FiRa Logical Service ID) to the second AC reader 930.

In operation 915, the first AC reader 920 may perform a service log off operation.

In operation 917, the second AC reader 930 may turn on (or activate) a service/application.

In operation 919, at least one of the AC device 910, the second AC reader 930, the web server 940, and the FIDO server 950 may optionally perform user re-authentication.

In operation 921, the web server 940 may transmit a third message (FiRa_APP_message_send_service continuity) for service continuity, including at least one of an ID of the AC device 910, service timestamp information, and a Service ID (or FiRa Logical Service ID), to the second AC reader 930.

In operation 923, the second AC reader 930 may be service-connected with the web server 940.

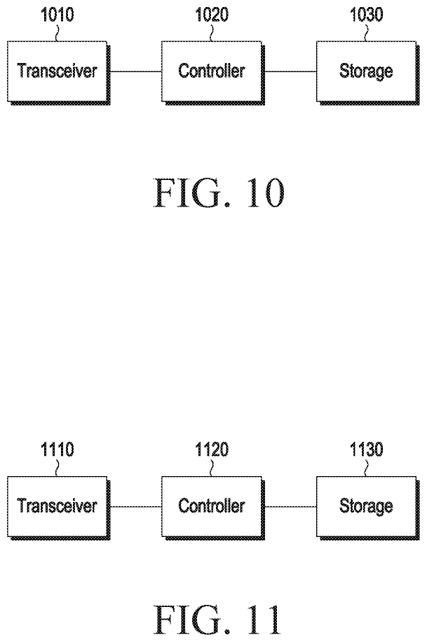

FIG. 10 is a device diagram illustrating a first UWB device according to an embodiment of the disclosure.

In the embodiment of FIG. 10, the first UWB device may be implemented as any one of the UWB device 100 of FIG. 1, the UWB device of FIG. 2, the first electronic device 301 of FIG. 3, the second electronic device 302, or the AC device illustrated in FIGS. 5 to 9.

Referring to FIG. 10, the first UWB device may include a transceiver 1010, a controller 1020, and a storage unit 1030. In the disclosure, the controller may be defined as a circuit or an application specific integrated circuit or at least one processor.

The transceiver 1010 may transmit/receive signals with other devices or servers. The transceiver 1010 may transmit/receive data to/from another UWB device through, e.g., UWB communication or OOB communication (e.g., BLE communication).

The controller 1020 may control the overall operation of the first UWB device according to the embodiment proposed in the disclosure. For example, the controller 1020 may perform the operations described with reference to FIGS. 1 to 9.

The storage unit 1030 may store at least one of information transmitted and received through the transceiver 1010 and information generated through the controller 1020. For example, the storage unit 1030 may store information and data necessary for the method described above with reference to FIGS. 1 to 9.

According to an embodiment, the controller 1020 may discover a second UWB device through device discovery based on Bluetooth low energy (BLE) communication or UWB communication, and perform UWB ranging with the second UWB device to identify whether the distance between the first UWB device and the second UWB device is equal to or less than a threshold. If the distance between the first UWB device and the second UWB device according to the UWB ranging result is equal to or less than the threshold, a device login or service execution procedure supported by the second UWB device may be performed.

According to an embodiment, the controller 1020 may receive a Poll message from the second UWB device and transmit a response message corresponding to the Poll message to the second UWB device. If the distance between the first UWB device and the second UWB device calculated based on the Poll message and the response message exceeds the threshold, a device log off or service termination procedure supported by the second UWB device may be performed.

According to an embodiment, the controller 1020 may register the first UWB device with a web server as a user authentication device, share a session key with the second UWB device and the web server, and perform UWB ranging with the second UWB device based on a scrambled timestamp sequence (STS) code generated using the session key.

According to an embodiment, the controller 1020 may perform a user authentication procedure using the STS code. When the user authentication procedure is completed, the second UWB device may receive a web service from the web server.

According to an embodiment, the controller 1020 may perform UWB ranging with the second UWB device, and if the distance between the first UWB device and the second UWB device as a result of the UWB ranging is equal to or greater than a threshold, receive a first message including at least one of an ID of the first UWB device and a service ID from the web server, and in response to the first message, transmit a second message including a flag indicating that the web service will continue to be used in the first UWB device to the web server.

FIG. 11 is a device diagram illustrating a second UWB device according to an embodiment of the disclosure.

In the embodiment of FIG. 11, the second UWB device may be implemented as any one of the UWB device 100 of FIG. 1, the UWB device of FIG. 2, the first electronic device 301 of FIG. 3, the second electronic device 302, or the AC reader illustrated in FIGS. 5 to 9.

Referring to FIG. 11, the second UWB device may include a transceiver 1110, a controller 1120, and a storage unit 1130. In the disclosure, the controller may be defined as a circuit or an application specific integrated circuit or at least one processor.

The transceiver 1110 may transmit/receive signals with other devices or servers. The transceiver 1110 may transmit/receive data to/from another UWB device through, e.g., UWB communication or OOB communication (e.g., BLE communication).

The controller 1120 may control the overall operation of the second UWB device according to the embodiment proposed in the disclosure. For example, the controller 1120 may perform the operations described with reference to FIGS. 1 to 9.

The storage unit 1130 may store at least one of information transmitted and received through the transceiver 1110 and information generated through the controller 1120. For example, the storage unit 1130 may store information and data necessary for the method described above with reference to FIGS. 1 to 9.

According to an embodiment, the controller 1120 may discover a first UWB device through device discovery based on Bluetooth low energy (BLE) communication or UWB communication, perform UWB ranging with the first UWB device to identify whether the distance between the first UWB device and the second UWB device is equal to or less than a threshold, and if the distance between the first UWB device and the second UWB device according to the UWB ranging result is equal to or less than the threshold, perform a device login or service execution procedure supported by the second UWB device.

According to an embodiment, the controller 1120 may transmit a Poll message to the first UWB device, receive a response message corresponding to the Poll message from the first UWB device, and if the distance between the first UWB device and the second UWB device calculated based on the Poll message and the response message exceeds the threshold, perform a device log off or service termination procedure supported by the second UWB device.

According to an embodiment, the controller 1120 may, if the first UWB device is registered with a web server as a user authentication device, share a session key with the first UWB device and the web server, and perform UWB ranging with the first UWB device based on a scrambled timestamp sequence (STS) code generated using the session key.

According to an embodiment, the controller 1120 may receive a web service from the web server if a user authentication procedure using the STS code is completed.

According to an embodiment, the controller 1120 may perform UWB ranging with the first UWB device, and if the distance between the first UWB device and the second UWB device as a result of the UWB ranging is equal to or greater than a threshold, transmit a third message including at least one of an ID of the first UWB device, service timestamp information, and a service ID to the web server. A third UWB device may continue to use the web service based on the third message.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

1. A method of operating a first ultra wide band (UWB) device, the method comprising:
discovering a second UWB device through device discovery based on Bluetooth low energy (BLE) communication or UWB communication; and
performing UWB ranging with the second UWB device to identify whether a distance between the first UWB device and the second UWB device is equal to or less than a threshold, wherein based on the distance between the first UWB device and the second UWB device according to the UWB ranging result being equal to or less than the threshold, a device login or service execution procedure supported by the second UWB device is performed.

2. The method of claim 1, further comprising:
receiving a Poll message from the second UWB device; and
transmitting a response message corresponding to the Poll message to the second UWB device, wherein based on the distance between the first UWB device and the second UWB device calculated based on the Poll message and the response message exceeding the threshold, a device log off or service termination procedure supported by the second UWB device is performed.

3. The method of claim 1, further comprising:
registering the first UWB device with a web server as a user authentication device;
sharing a session key with the second UWB device and the web server; and
performing UWB ranging with the second UWB device based on a scrambled timestamp sequence (STS) code generated using the session key.

4. The method of claim 3, further comprising performing a user authentication procedure using the STS code, wherein based on the user authentication procedure being completed, a web service is provided from the web server through the second UWB device.

5. The method of claim 4, further comprising:
performing UWB ranging with the second UWB device;
based on the distance between the first UWB device and the second UWB device as a result of the UWB ranging being equal to or greater than a threshold, receiving a first message including at least one of an ID of the first UWB device and a service ID from the web server; and
in response to the first message, transmitting a second message including a flag indicating that the web service will continue to be used in the first UWB device to the web server.

6. A method of operating a second ultra wide band (UWB) device, the method comprising:
discovering a first UWB device through device discovery based on Bluetooth low energy (BLE) communication or UWB communication;
performing UWB ranging with the first UWB device to identify whether a distance between the first UWB device and the second UWB device is equal to or less than a threshold; and
based on the distance between the first UWB device and the second UWB device according to the UWB ranging result being equal to or less than the threshold, performing a device login or service execution procedure supported by the second UWB device.

7. The method of claim 6, further comprising:
transmitting a Poll message to the first UWB device;
receiving a response message corresponding to the Poll message from the first UWB device; and
based on the distance between the first UWB device and the second UWB device calculated based on the Poll message and the response message exceeding the threshold, performing a device log off or service termination procedure supported by the second UWB device.

8. The method of claim 6, further comprising:
based on the first UWB device being registered with a web server as a user authentication device, sharing a session key with the first UWB device and the web server; and
performing UWB ranging with the first UWB device based on a scrambled timestamp sequence (STS) code generated using the session key.

9. The method of claim 8, further comprising, based on a user authentication procedure using the STS code being completed, receiving a web service from the web server.

10. The method of claim 9, further comprising:
performing UWB ranging with the first UWB device; and
based on the distance between the first UWB device and the second UWB device as a result of the UWB ranging being equal to or greater than a threshold, transmitting a third message including at least one of an ID of the first UWB device, service timestamp information, and a service ID to the web server, wherein a third UWB device continues to use the web service based on the third message.

11. A first ultra wide band (UWB) device comprising:
a transceiver; and
a controller,
wherein the controller is configured to:
discover a second UWB device through device discovery based on Bluetooth low energy (BLE) communication or UWB communication, and
perform UWB ranging with the second UWB device to identify whether a distance between the first UWB device and the second UWB device is equal to or less than a threshold, wherein based on the distance between the first UWB device and the second UWB device according to the UWB ranging result being equal to or less than the threshold, a device login or service execution procedure supported by the second UWB device is performed.

12. The device of claim 11, wherein the controller is configured to:
receive a Poll message from the second UWB device; and
transmit a response message corresponding to the Poll message to the second UWB device, wherein based on the distance between the first UWB device and the second UWB device calculated based on the Poll message and the response message exceeding the threshold, a device log off or service termination procedure supported by the second UWB device is performed.

13. The device of claim 11, wherein the controller is configured to:
register the first UWB device with a web server as a user authentication device;
share a session key with the second UWB device and the web server, and
perform UWB ranging with the second UWB device based on a scrambled timestamp sequence (STS) code generated using the session key.

14. A second ultra wide band (UWB) device comprising:
a transceiver; and
a controller,
wherein the controller is configured to:
discover a first UWB device through device discovery based on Bluetooth low energy (BLE) communication or UWB communication,
perform UWB ranging with the first UWB device to identify whether a distance between the first UWB device and the second UWB device is equal to or less than a threshold, and
based on the distance between the first UWB device and the second UWB device according to the UWB ranging result being equal to or less than the threshold, perform a device login or service execution procedure supported by the second UWB device.

15. The device of claim 14, wherein the controller is configured to:
transmit a Poll message to the first UWB device;
receive a response message corresponding to the Poll message from the first UWB device, and
based on the distance between the first UWB device and the second UWB device calculated based on the Poll message and the response message exceeding the threshold, perform a device log off or service termination procedure supported by the second UWB device.
